(19) United States
(12) Patent Application Publication
(10) Pub. No.: US 2021/0336812 A1
(43) Pub. Date: Oct. 28, 2021

(54) SELECTIVE SIGHT VIEWING

(71) Applicant: Detlev Kerstan, Hattersheim (DE)

(72) Inventor: Detlev Kerstan, Hattersheim (DE)

(73) Assignee: Unisys Corporation, Blue Bell, PA (US)

(21) Appl. No.: 16/858,811

(22) Filed: Apr. 27, 2020

(51) Int. Cl. H04L 12/18; H04L 29/06; H04N 21/454

(52) U.S. Cl. CPC H04L 12/1822; H04N 21/4542; H04L 65/403; H04L 12/1831

(57) ABSTRACT

A video conferencing system includes a video camera, a computer device and a remote device. The video camera captures video from a field of view and translates the video into digital video data. The computer device is connected to the video camera for receiving the digital video data. The computer device also has software that enables a user to select allowed or blocked portions of the video. The remote device is connected to the computer device via a communications link and the remote device receives only the allowed video. Thus a user can selectively choose what portions of the video available in the field of view are transmitted to the remote device and what portions of the video available in the field of view are not transmitted to the remote device. A computer implemented method of selectively allowing video transmission includes receiving an indication of video to allow or block; modifying a video stream to block all but allowed video content; and transmitting only the allowed video content to a remote site.

### FIELD OF THE DISCLOSURE

The present application relates generally to a video transmission, and more particularly to selecting which portion of video to transmit.

### BACKGROUND

Video is widely used around the world for video conferences, sharing of information and collaboration. One challenge with video is that the camera shows everything it sees. For example, the video may show a person talking and in the background is a white board with information on it. The video being transmitted would include both the person and the background. The information on the white board might be sensitive information that should not be shared. In the past a solution might be to zoom the camera to a specific area so that only that area, which is desired, is transmitted. i.e. zoom in on the person so that the white board is less visible. One problem with this is that the person conducting the video conference might not realize that the white board is in view or even that it contains sensitive information. Another problem is that even if the camera is zoomed in on the person, a portion of the white board may still be visible. Therefore, improvements are desirable.

### SUMMARY

In a first aspect of the present invention, a video conferencing system includes a video camera, a computer device and a remote device. The video camera captures video from a field of view and translates the video into digital video data. The computer device is connected to the video camera for receiving the digital video data. The computer device also has software that enables a user to select allowed or blocked portions of the video. The remote device is connected to the computer device via a communications link and the remote device receives only the allowed video. Thus a user can selectively choose what portions of the video available in the field of view are transmitted to the remote device and what portions of the video available in the field of view are not transmitted to the remote device.

In a second aspect of the present invention, a computer implemented method of selectively allowing video transmission includes receiving an indication of video to allow or block; modifying a video steam to block all but allowed video content; and transmitting only the allowed video content to a remote site.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the disclosed system and methods, reference is now made to the following descriptions taken in conjunction with the accompanying drawings.

FIG. 1 is a block diagram illustrating an encrypted enclave of virtual machines organized into communities-of-interest, according to one embodiment of the present invention;

FIG. 2 is a block diagram illustrating a network implementing communities-of-interest, according to one embodiment of the present invention;

FIG. 3 is a block diagram illustrating an enclave included in the network of FIG. 2;

FIG. 4 is a schematic diagram of a system for selective sight video transmission, according to one example embodiment of the present invention;

FIG. 5 is a schematic diagram of a system for selective sight video transmission, according to another example embodiment of the present invention.

FIG. 6 is a schematic diagram of a system for selective sight video transmission, according to another example embodiment of the present invention.

FIG. 7 is a schematic diagram of a system for selective sight video transmission, according to another example embodiment of the present invention.

FIG. 8 is a block diagram illustrating a computer network, according to one example embodiment of the present invention;

FIG. 9 is a block diagram illustrating a computer system, according to one example embodiment of the present invention; and

FIG. 10 is a flow diagram of a method of selectively allowing video transmission using the system of FIGS. 4-7, according to one example embodiment of the present invention.

### DETAILED DESCRIPTION

Video Conferencing allows people at two or more locations to see and hear each other at the same time, using computer and communications technology. Video conferencing is widely used around the world for video conferences, sharing of information and collaboration. The video conference exchanges visual information with Webcams, which are digital video cameras and streaming video. Audio content may also be exchanged or could be distributed separately for example by a telephone.

Video input from the camera and audio input from a microphone are converted to digital data. Typically software compresses the digital data so that it can travel more quickly via ISDN lines, broadband Internet or Wifi. When the data reaches its destination, it is decompressed to be viewed on a computer monitor or television screen and heard through speakers. Acoustic echo cancellation software is typically used to remove sound interference and eliminate delays so that sound and visuals are in synch.

Video conferencing software often combine Web page tools and Internet communication into one interface to create an interactive meeting environment. These tools can include HTML, XML and ASP markup; Java scripts; flash animation; instant messaging, streaming audio and video; and collaboration tools that allow files to be shared, accessed and edited together.

A challenge with video is that the camera shows everything it sees. For example, the video may show a person talking and in the background is a white board with information on it. The video being transmitted would include both the person and the background visible to the camera. The information on the white board might be sensitive information that should not be shared. In the past a solution would be to zoom the camera to a specific area so that only the area, which is desired, is transmitted. i.e. zoom in on the person so that the white board is less visible. One problem with this is that the person conducting the video conference might not realize that the white board is in view or even that it contains sensitive information. Another problem is that even if the camera is zoomed in on the person, a portion of the white board may still be visible.

Another challenge with video conferencing is security. Stealth enterprise security solution from Unisys Corporation of Blue Bell, Pa. can be used to implement features of the present disclosure. Stealth can be used to protect the end to end data communications and make the endpoints go dark on the Internet. As with other Stealth applications, not all endpoints require Stealth protection.

Stealth reduces attack surfaces in an environment by creating dynamic, identity-driven microsegments called communities-of-interest. Micro segmentation is a security strategy that segments a network into smaller elements and manages them with IT security policies. By establishing secure community-of-interest, Stealth separates trusted systems, users and data from the untrusted. It further reduces attack surfaces by encrypting all communication between Stealth protected assets and cloaking the assets from unauthorized users. Micro segmentation divides a physical network into multiple logical micro-segments. Only the resources within the micro segment can see and access one another.

For example, virtual machines executing on one or more servers may each be assigned one or more communities-of-interest. The communities-of-interest may allow an administrator to create logical organizations of virtual machines. A community-of-interest may be defined by a role of the virtual machines in the community-of-interest.

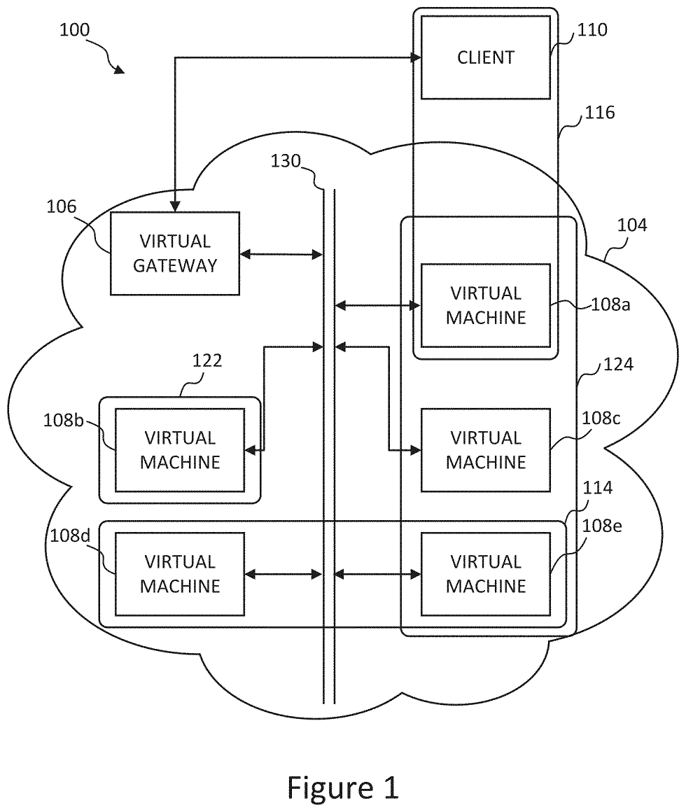

Messages or communications within a community-of-interest are encrypted with a key corresponding to the community-of-interest. In this fashion, messages or communications are cryptographically isolated. FIG. 1 is a block diagram illustrating an encrypted enclave of virtual machines organized into communities-of-interest according to one example embodiment of the present disclosure. A network 100 may include a network bus 130 serving an enclave 104. The bus 130 may couple virtual machines 108a-e within the enclave 104. Each of the virtual machines 108a-e may communicate through encrypted communications carried on the bus 130. A virtual gateway 106 may be coupled to the bus 130 to provide communications from the enclave 104 to external devices, such as a client 110 and/or other public networks, such as the Internet. The client 110 may be a remoted device, such as a personal computer or mobile device. The client 110 may be connected to the virtual gateway 106 through a secured tunnel, such that the communications between the client 110 and the virtual gateway 106 are encrypted similar to the encrypted communications on the bus 130.

The virtual machines 108a-e may be assigned to one or more communities-of-interest. For example, the virtual machines 108a, 108c, and 108e may be assigned to community-of-interest 124. Virtual machines 108d and 108e may be assigned to community-of-interest 114. And, virtual machine 108b may be assigned to community-of-interest 122. And, the virtual machine 108a and the client 110 may be assigned community-of-interest 116.

A virtual machine 108e may be instructed to transmit a message to the virtual machine 108a. For example, software executing on the virtual machine 108e may request data from a database server executing on the virtual machine 108e may request data from a database server executing on the virtual machine 108a. When the virtual machine 108e receives the message destined for the virtual machine 108a, the virtual machine 108e may identify a community-of-interest in common between virtual machine 108e and virtual machine 108a. The community-of-interest 124 may be identified and a key associated with COI 124 may be used to encrypt the message.

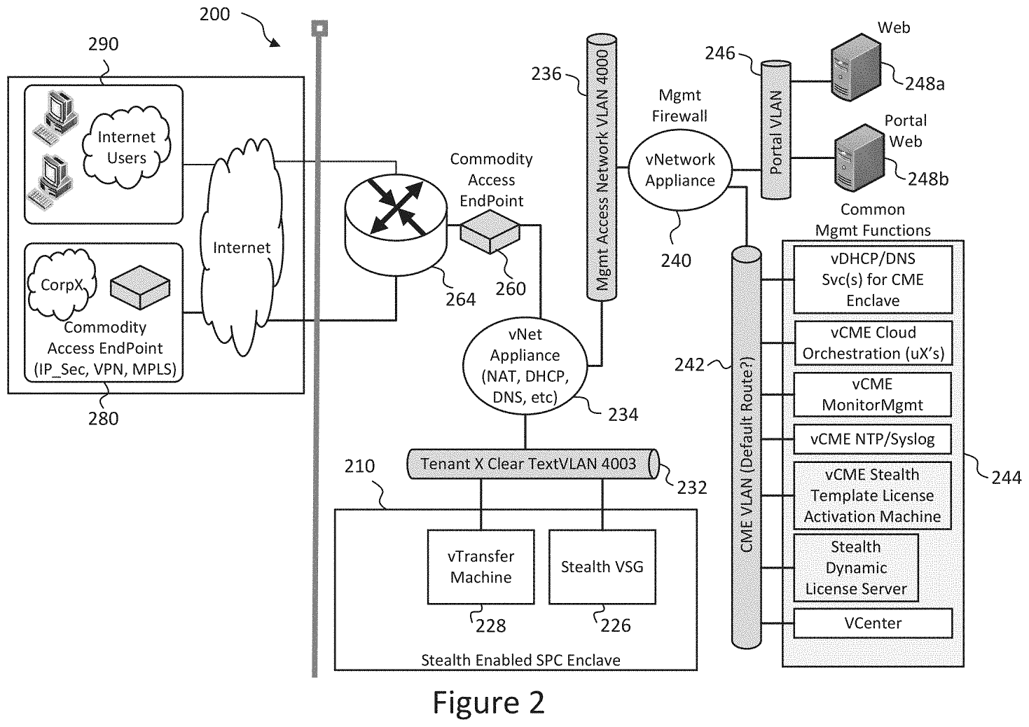

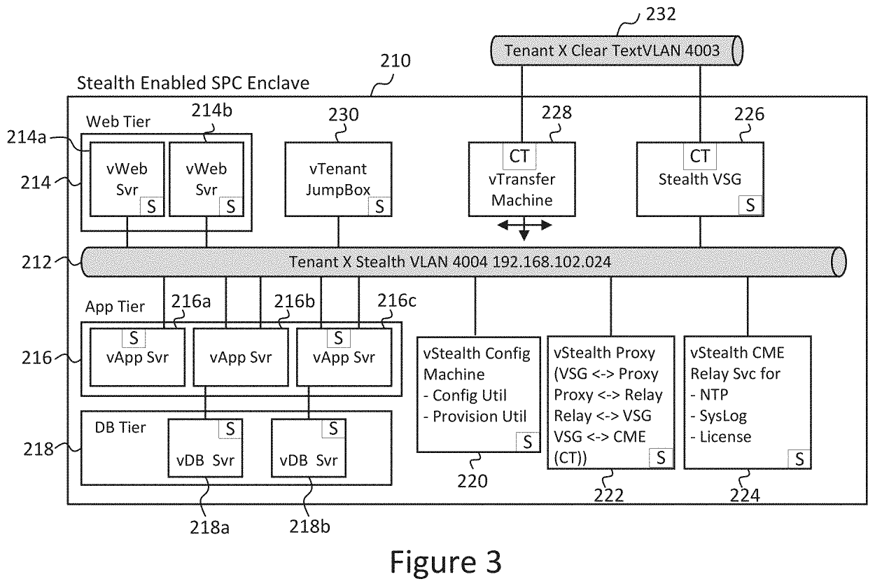

The community-of-interest organization of virtual machines may be implemented in a computer network to provide cryptographic isolation of virtual machines. FIGS. 2 and 3 are block diagrams illustrating a network implementing communities-of-interest according to one embodiment of the disclosure. A network 200 may include an enclave 210. According to one embodiment, the enclave 210 may belong to a single tenant of the network 200. In other embodiments, the enclave 210 may be shared between tenants.

Communities-of-interest may be configured for a web tier 214, an application tier 216, and a database tier 218. The web tier 214 may include a number of web servers 214a-b, the application tier 216 may include a number of application servers 216a-c, and the database tier 218 may include a number of database servers 218a-b. Each of the servers 214a-b, 216a-c, and 218a-b may be a virtual server executing within a virtual machine. Additional communities-of-interest may be defined for infrastructure functions, such as an administrator community-of-interest key COI, a relay COI, an application tier management COI, a database tier management COI, and a jumpbox management COI. The enclave 210 may also include a jumpbox 230, a transfer machine 228, a virtual gateway 226, a relay 224, a proxy 222, and a configuration device 220, which may also be executing in virtual machines.

Membership of the virtual machines in individual COIs are shown as numbered circles. Each circle may represent a different COI, such as the web tier COI. For example, a web tier COI may include the servers 214a-b, the jumpbox 230, and the virtual gateway 226. According to one embodiment, only virtual machines that share a common COI may communicate. When a first virtual machine initiates communication with a second virtual machine, the first virtual machine may search for a common COI between the first and the second virtual machine. If found, a cryptographic session key may be created that is encrypted with a key associated with the common COI. Thus, only a virtual machine that shares the COI key may decrypt the session key. All communication between the two virtual machines may be encrypted and decrypted with the session key. Messages within the enclave 210 may be isolated from the rest of the network 200, because the messages are encrypted with keys that are not available to the rest of the network 200.

For example, a web server virtual machine 214a may be able to communicate with another web server virtual machine 214b, because the virtual machines 214a-b have the web tier COI in common. They may also be able to communicate with application server virtual machines 216a-c, because the machines 214a-b and 216a-c have the application tier COI in common.

Each of the devices within the enclave 210 may be coupled to a bus 212. When a device within the enclave 210 communicates with devices outside the enclave 210, then messages may be handled by the virtual gateway 226, which may be coupled to an unencrypted network 232. According to one embodiment, the virtual gateway 226 may encrypt and/or decrypt messages between the enclave 210 and the unencrypted network 232. The network 232 may couple the enclave 210 to other network appliances 234, such as network address translation (NAT) devices, dynamic host control protocol (DHCP) devices, domain name service (DNS) devices, and the like. The other network appliances 234 may also be executing in virtual machines.

Access to the enclave 210 may be controlled by the virtual gateway 226. Messages passing through the gateway 226 from the unencrypted, or clear-text, network 222 to the enclave 210 may be encrypted and messages in the other direction may be decrypted by the gateway 226. According to one embodiment, messages within the enclave 210 may only be transmitted to a virtual machine that has a COI in common with the gateway 226. Furthermore, the gateway 226 may be configured to filter messages for a COI. The filter may allow an administrator to restrict access based on a message's source and/or destination address and/or port. The enclave 210 may also be isolated from other enclaves (not shown) in the network 200, because only a virtual machine having a common COI with the gateway 226 may communicate outside of the enclave 210.

For example, the web servers 214a-b may be able to communicate through the gateway 226, because the web servers 214a-b share the web tier COI with the gateway 226. In another example, the application servers 216a-c and the database servers 218a-b may have restricted access through the gateway 226, because the gateway 226 may filter messages transmitted in the application COI and the database COI to only provide access to management devices 244.

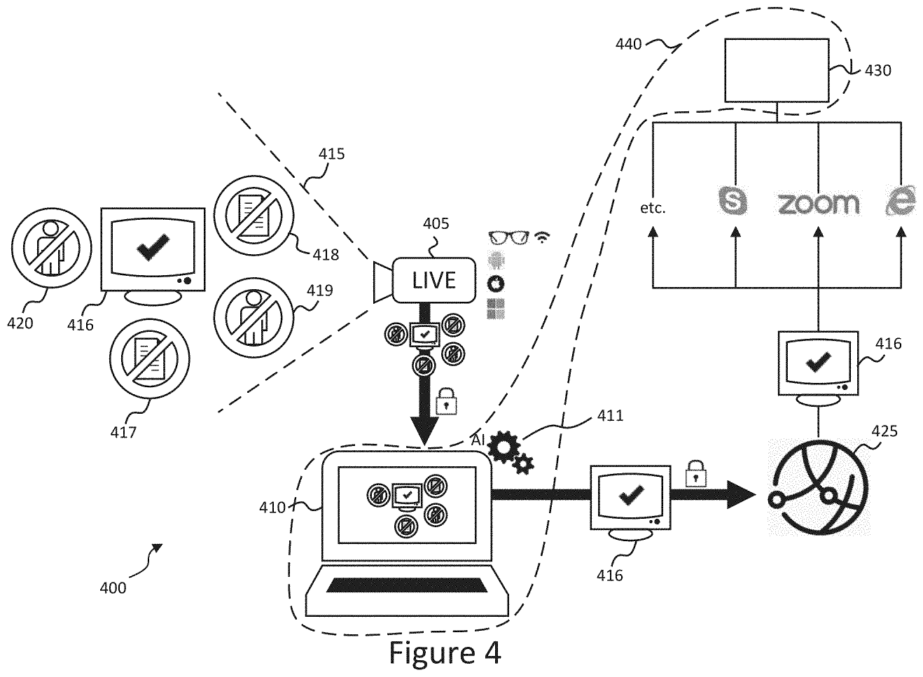

FIG. 4 is a schematic overview of a selective sight system 400. The system 400 includes a video camera 405 connected to a computer 410 running an algorithm or Artificial Intelligence 411. The video camera 405 has a field of view 415 depicted by the dash lines. In one example, the field of view has numerous items within it, including a screen 416, documents 417, 418 and people 419, 420. The video camera 405 captures live video within its field of view 415 and converts the video to a digital data stream for transfer to the computer 410. Within the digital data stream, all of the items 416, 417, 418, 419 and 420 are included and transferred to the computer 410. Using the computer 410 and software on the computer, a user can select which items should be blocked from transmission to another party via remote device 430. In the example depicted in FIG. 4, the user chose to block items 417, 418, 419 and 420 from transmission and allowed item 416 to be transmitted to the remote device 430. The user could block or allow any number of items.

The computer 410 is connected to the Internet 425, which can be connected to a remote site 430. Video conferencing software can be used to facilitate the video conference, for example Zoom. This solution is particularly useful in secure areas or areas where unrestricted video transmission may pose problems (people, intellectual property, unsuitable content). A user can quickly and easily define the area that is to be transmitted and what is to be blacked/whited out (i.e. not transmitted).

The above system 400 could incorporate Stealth as well. In one example, the computer 410 and remote device 430 might use Stealth to protect their communications. Thus a community of interest 440 might include the computer 410 and the remote device 430. The devices 410, 430 would have Stealth installed on them.

It is noted, that although examples used herein are showing a screen is to be transmitted and other items are not, other suitable uses exist. For example, it could transmit only a certain area of a room (door, corner, window, etc.), a server rack, a single server within a rack, only part of a server, a specific person (even while in motion), part of a body where a surgery is performed, etc. Everything outside of the allowed area would be either concealed or transmitted. For discussion purposes, Whitelisting means transmitting everything within the defined area. Blacklisting means everything outside of the defined area will be transmitted. By using different marker devices for Blacklist and Whitelist, a combination of these modes is also possible. Other video capturing devices are also possible, for example, Smart Glasses, webcams, smartphone cameras, etc.

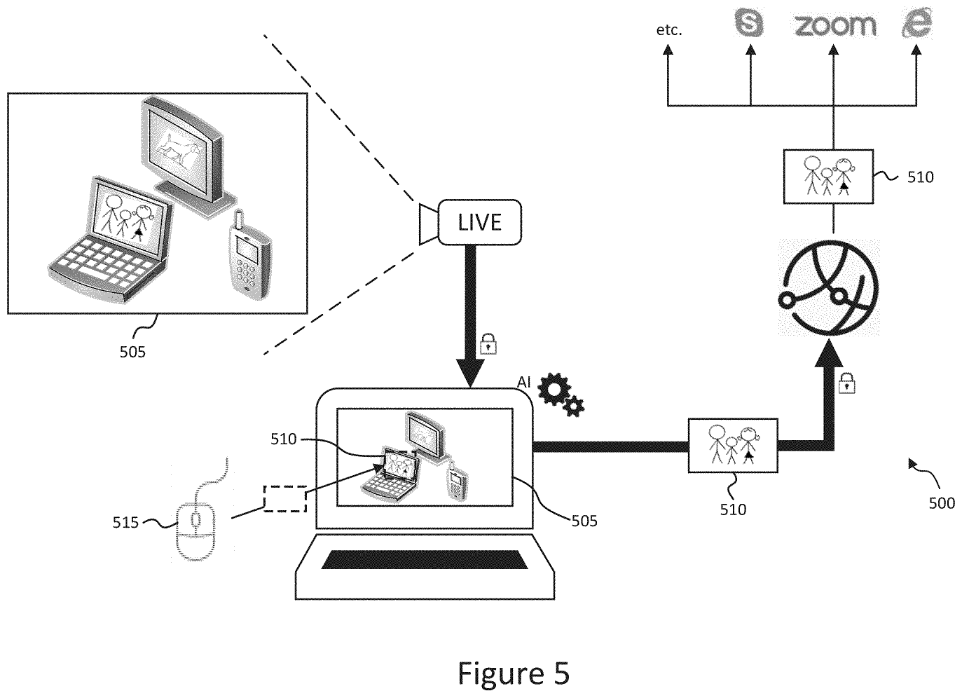

Referring to FIG. 5, a selective site video system 500 is shown. One example of marking the video could be initially using a recorded picture 505 from the initial video stream. An allowed area 510 could be marked using a pointing device, such as a mouse 515. Only that allowed area 510 is transmitted to a remote site. System 500 could also mark video from a live video stream.

When using smart glasses (or other body mounted camera, i.e. a GoPro), the person can transmit only a certain area of what the glasses are recording (e.g. the person's monitor screen). All other information will be omitted from the video stream, thus allowing the person to also look around the room and go to the break room and get coffee. Everything would be blocked except for the monitor when the camera sees the monitor. In other words, as the user leaves her monitor, the screen seen at the remote end would be blank as the camera cannot see the monitor. When the user returns after getting coffee and is facing the monitor, the screen seen at the remote end would not show the monitor again.

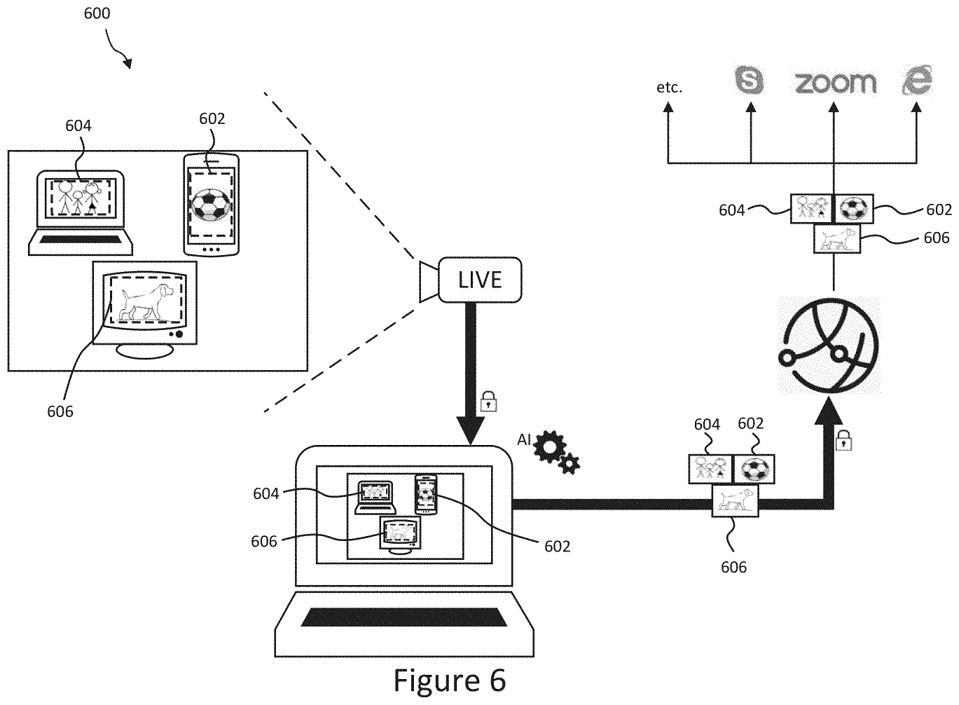

Referring to FIG. 6, a selection site video system 600 is shown. In this example embodiment, multiple areas 602, 604, 606 can be selected for transmission.

It also possible to predefine areas for use by a user or use barcodes to allow quick scanning of allowed or disallowed areas.

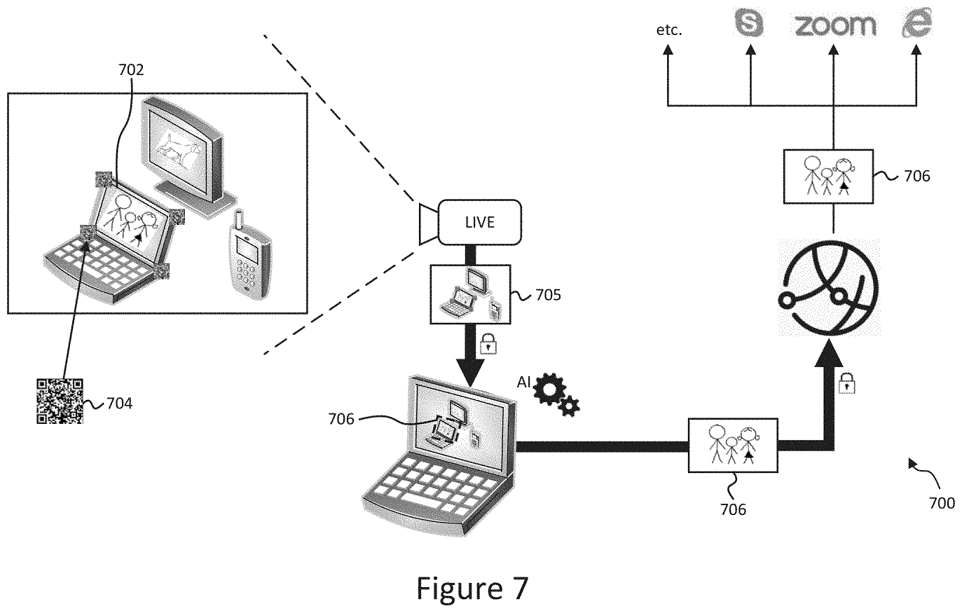

Referring to FIG. 7, selective site video system 700 is shown. In this example embodiment, a laptop 702 has a barcode(s) 704 affixed to it, which enables the software to identify it as the area 706 to be allowed. Similarly, an electronic transmitting device could be used to identify allowed areas.

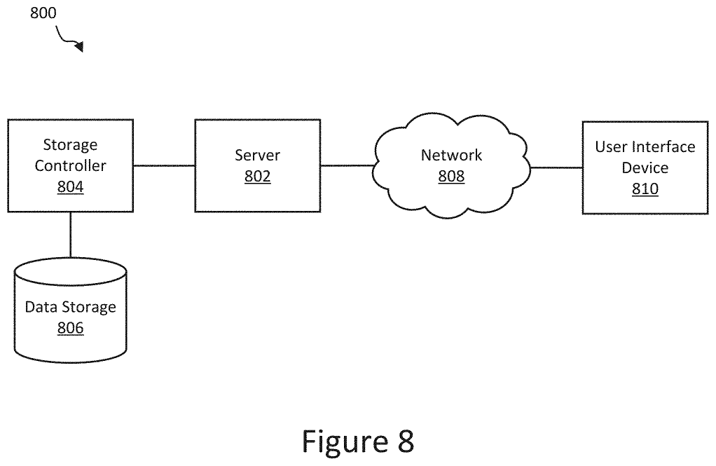

FIG. 8 illustrates one embodiment of a system 800 for an information system, which may host virtual machines. The system 800 may include a server 802, a data storage device 806, a network 808, and a user interface device 810. The server 802 may be a dedicated server or one server in a cloud computing system. The server 802 may also be a hypervisor-based system executing one or more guest partitions. The user interface device 810 may be, for example, a mobile device operated by a tenant administrator. In a further embodiment, the system 800 may include a storage controller 804, or storage server configured to manage data communications between the data storage device 806 and the server 802 or other components in communication with the network 808. In an alternative embodiment, the storage controller 804 may be coupled to the network 808.

In one embodiment, the user interface device 810 is referred to broadly and is intended to encompass a suitable processor-based device such as a desktop computer, a laptop computer, a personal digital assistant (PDA) or tablet computer, a smartphone or other a mobile communication device having access to the network 808. The user interface device 810 may be used to access a web service executing on the server 802. When the device 810 is a mobile device, sensors (not shown), such as a camera or accelerometer, may be embedded in the device 810. When the device 810 is a desktop computer the sensors may be embedded in an attachment (not shown) to the device 810. In a further embodiment, the user interface device 810 may access the Internet or other wide area or local area network to access a web application or web service hosted by the server 802 and provide a user interface for enabling a user to enter or receive information.

The network 808 may facilitate communications of data, such as dynamic license request messages, between the server 802 and the user interface device 810. The network 808 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

In one embodiment, the user interface device 810 accesses the server 802 through an intermediate sever (not shown). For example, in a cloud application the user interface device 810 may access an application server. The application server may fulfill requests from the user interface device 810 by accessing a database management system (DBMS). In this embodiment, the user interface device 810 may be a computer or phone executing a Java application making requests to a JBOSS server executing on a Linux server, which fulfills the requests by accessing a relational database management system (RDMS) on a mainframe server.

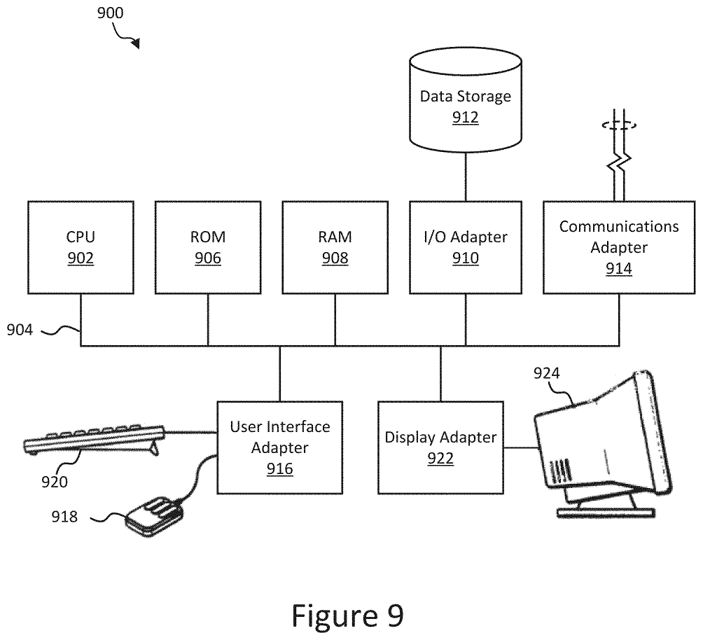

FIG. 9 illustrates a computer system 900 adapted according to certain embodiments of the server 802 and/or the user interface device 810. The central processing unit (“CPU”) 902 is coupled to the system bus 904. The CPU 902 may be a general purpose CPU or microprocessor, graphics processing unit (“GPU”), and/or microcontroller. The present embodiments are not restricted by the architecture of the CPU 902 so long as the CPU 902, whether directly or indirectly, supports the operations as described herein. The CPU 902 may execute the various logical instructions according to the present embodiments.

The computer system 900 also may include random access memory (RAM) 908, which may be synchronous RAM (SRAM), dynamic RAM (DRAM), synchronous dynamic RAM (SDRAM), or the like. The computer system 900 may utilize RAM 908 to store the various data structures used by a software application. The computer system 900 may also include read only memory (ROM) 906 which may be PROM, EPROM, EEPROM, optical storage, or the like. The ROM may store configuration information for booting the computer system 900. The RAM 908 and the ROM 906 hold user and system data, and both the RAM 908 and the ROM 906 may be randomly accessed.

The computer system 900 may also include an input/output (I/O) adapter 910, a communications adapter 914, a user interface adapter 916, and a display adapter 922. The I/O adapter 910 and/or the user interface adapter 916 may, in certain embodiments, enable a user to interact with the computer system 900. In a further embodiment, the display adapter 922 may display a graphical user interface (GUI) associated with a software or web-based application on a display device 924, such as a monitor or touch screen.

The I/O adapter 910 may couple one or more storage devices 912, such as one or more of a hard drive, a solid state storage device, a flash drive, a compact disc (CD) drive, a floppy disk drive, and a tape drive, to the computer system 900. According to one embodiment, the data storage 912 may be a separate server coupled to the computer system 900 through a network connection to the I/O adapter 910. The communications adapter 914 may be adapted to couple the computer system 900 to the network 908, which may be one or more of a LAN, WAN, and/or the Internet. The communications adapter 914 may also be adapted to couple the computer system 900 to other networks such as a global positioning system (GPS) or a Bluetooth network. The user interface adapter 916 couples user input devices, such as a keyboard 920, a pointing device 918, and/or a touch screen (not shown) to the computer system 900. The keyboard 920 may be an on-screen keyboard displayed on a touch panel. Additional devices (not shown) such as a camera, microphone, video camera, accelerometer, compass, and or gyroscope may be coupled to the user interface adapter 916. The display adapter 922 may be driven by the CPU 902 to control the display on the display device 924. Any of the devices 902-922 may be physical and/or logical.

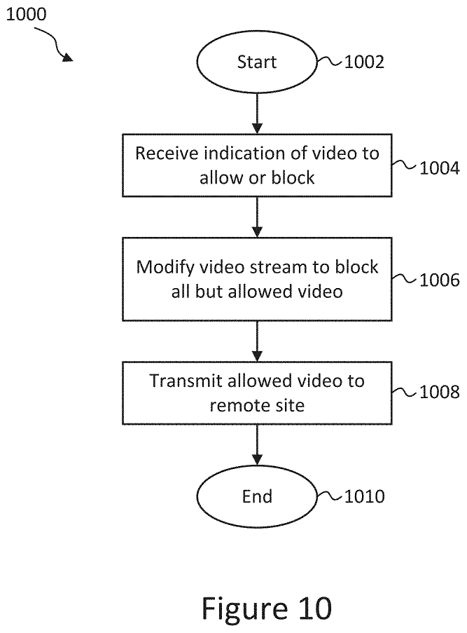

FIG. 10 is a flow diagram of a method for selectively transmitting video 1000. In use, a user would select a portion of a video stream to allow. The computer at 1004 would receive an indication of a video to allow or block depending on whether the user is using Whitelisting markers or Blacklisting markers. The computer would then block all portions of the video that are not allowed 1006 or vice versa, depending on whether user is using Whitelisting markers or Blacklisting markers. As discussed herein, both Whitelisting and Blacklisting could also be used in combination. The computer would then send only the allowed video to a remote site 1008.

The applications of the present disclosure are not limited to the architecture of computer system 900. Rather the computer system 900 is provided as an example of one type of computing device that may be adapted to perform the functions of a server 802 and/or the user interface device 810. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 900 may be virtualized for access by multiple users and/or applications. The applications could also be performed in a serverless environment, such as the cloud.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media. A serverless environment, such as the cloud, could also be used.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims. A serverless environment, such as the cloud, could also be used.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A video conferencing system comprising:
a video camera for capturing video from a field of view and translating the video into digital video data;
a computer device connected to the video camera for receiving the digital video data, the computer device having software enabling a user to select an object to block from transmission to create an allowed video for transmission; and
a remote device connected to the computer device via a communications link, the remote device receiving only the allowed video;
wherein a user can selectively choose what portions of the video available in the field of view are transmitted to the remote device and what objects of the video available in the field of view are not transmitted to the remote device.

2. The video conferencing system of claim 1, wherein the remote device and the computer device are part of a community-of-interest.

3. The video conferencing system of claim 2, wherein the remote device and the computer device both have security software installed.

4. The video conferencing system of claim 3, wherein the security software utilizes communities-of-interest.

5. The video conferencing system of claim 1, wherein the computer device and remote device communicate through the Internet using standard video conferring software.

6. The video conferencing system of claim 1, wherein the computer device has software enabling the user to use whitelisting or blacklisting to select allowed or blocked portions of the video.

7. The video conferencing system of claim 1, wherein the computer device has software to recognize barcodes to define areas or objects that are to be allowed or blocked.

8. The video conferencing system of claim 1, wherein the computer device has software to recognize electronic transmitting devices to define areas or objects that are to be allowed or blocked.

9. A computer device for video conferencing, the computer device comprising:
software for receiving digital video data from a video camera corresponding to a video; and
software for enabling a user to select objects to block from transmission to create an allowed video for transmission to a remote device connected to the computer device via a communications link, the remote device receiving only the allowed video;
wherein a user can selectively choose what portions of the video are transmitted to the remote device and what objects of the video are not transmitted to the remote device.

10. The computer device of claim 9, wherein the remote device and the computer device are part of a community-of-interest.

11. The video conferencing system of claim 10, wherein the remote device and the computer device both have security software installed.

12. The video conferencing system of claim 11, wherein the security software utilizes communities of interest.

13. The video conferencing system of claim 9, wherein the computer device and remote device communicate through the Internet using standard video conferring software.

14. The video conferencing system of claim 9, wherein the computer device has software enabling the user to use whitelisting or blacklisting to select allowed or blocked portions of the video.

15. The video conferencing system of claim 9, wherein the computer device has software to recognize barcodes to define areas or objects that are to be allowed or blocked.

16. The video conferencing system of claim 9, wherein the computer device has software to recognize electronic transmitting devices to define areas or objects that are to be allowed or blocked.

17. A computer implemented method of selectively allowing video transmission, the method comprising:
receiving an indication of an object to block;
modifying the video to block the object and create an allowed video; and
transmitting only the allowed video to a remote site.

18. The computer implemented method of claim 17, wherein transmitting includes using encrypted transmission to the remote site.

19. The computer implemented method of claim 17, wherein the remote site has a community-of-interest key for unencrypting the video transmission.

20. The computer implemented method of claim 17, wherein receiving an indication includes receiving an indication of a video to allow or block using whitelisting or blacklisting.
